(19) United States
(12) Patent Application Publication
(10) Pub. No.: US 2016/0269431 A1
(43) Pub. Date: Sep. 15, 2016

(54) PREDICTIVE ANALYTICS UTILIZING REAL TIME EVENTS

(71) Applicant: HEWLETT PACKARD ENTERPRISE DEVELOPMENT LP, Houston, TX (US)

(72) Inventor: Anurag Singla, Sunnyvale, CA (US)

(21) Appl. No.: 15/031,503

(22) PCT Filed: Jan. 29, 2014
(86) PCT No.: PCT/US2014/013500

§ 371 Date: Apr. 22, 2016

(51) Int. Cl. H04L 29/06; G06F 21/57; G06F 21/55

(52) U.S. Cl. CPC H04L 63/1425; G06F 21/552; G06F 21/577; H04L 63/1416; G06F 2221/2115

(57) ABSTRACT

A method and system for providing predictive analytics which include calculating forecast trend curves utilizing historical events, determining which of the forecast trend curves best fit the historical events to form a first best fit forecast trend curve, comparing predicted events from the first best fit forecast trend curve with real-time events, based on the real-time security events deviating from the first best fit forecast trend curve by a threshold amount, calculating additional forecast trend curves utilizing the real-time events, and determining which of the forecast trend curves and first best fit forecast trend curve best fits the real-time events to form a second best fit forecast trend curve.

### BACKGROUND

Security Information and Event Management (SIEM) technology provides real-time analysis of security alerts generated by network hardware and applications. SIEM technology can detect possible threats to a computing network. These possible threats can be determined from an analysis of security events.

### BRIEF DESCRIPTION OF THE DRAWINGS

For a detailed description of various examples, reference will now be made to the accompanying drawings in which:

FIG. 1 shows a block diagram of an adaptive predictive analytics system, according to an example;

FIG. 2 shows a block diagram of an adaptive predictive analytics device, according to an example;

FIG. 3 shows an example forecast trend curve;

FIG. 4 shows an example forecast trend curve;

FIG. 5 shows a flowchart of a method for providing adaptive predictive analytics utilizing real-time security events, according to an example;

FIG. 6 shows a flowchart of a method for providing adaptive predictive analytics utilizing real-time security events, according to an example; and

FIG. 7 is a block diagram of a computing device capable of providing adaptive predictive analytics using real-time security events, according to an example.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Security information/event management (SIM or SIEM) systems are generally concerned with collecting data from networks and networked devices that reflect network activity and/or operation of the devices and analyzing the data to enhance security. For example, data can be analyzed to identify an attack on the network or a networked device and determine which user or machine is responsible. If the attack is ongoing, a countermeasure can be performed to thwart the attack or mitigate the damage caused by the attack. The data that can be collected can originate in a message (e.g., an event, alert, alarm, etc.) or an entry in a log file, which is generated by a networked device. Example networked devices include firewalls, intrusion detection systems, servers, etc. In one example, each message or log file entry (“security event”) can be stored for future use. Stored security events can be organized in a variety of ways. Security events may include network traffic information, number of attacks, number of assets exploited and the like.

There are numerous internet protocol (IP) address based devices on the Internet and/or other networks. Many of these devices may have malicious code executing. Further, employees or other individuals with physical access to a network may pose a security threat. Traffic from any of the potentially malicious devices to an enterprise should be scrutinized for any malicious behavior. Also, the kind of attack pattern from these devices and the vulnerabilities that these devices can exploit can vary over a large range. SIEM technology can identify a large range of threats such as risks and/or exploits.

Additionally, predicting future security events may allow network administrators to optimize the network or take preemptive actions that prevent malicious code from executing, thereby protecting the network or specific network node. Thus, it is desirable to have an accurate future forecast trend which predicts various security events.

Accordingly, various examples herein describe adaptive predictive analytics devices and methods which may be used with a SIEM system. The predictive analytics device may be a standalone device or part of another larger device. Utilizing previously stored security events (“historical security events”), the predictive analytics device can calculate multiple forecast trend curves utilizing mathematical formulas that calculate future values based upon past values (“model curves”). A forecast trend curve is a curve which indicates forecast security events. The predictive analytics device then may determine which of the model curves best approximates (“best fits”) the historical security events. A curve that best fits the security events data is the curve that best represents the security events data. A best fit may be determined utilizing any algorithm, so long as the algorithm makes a determination as to which model curve it determines best approximates the security events. The model curve that best fits the historical security events then may be utilized by the SIEM system to predict future security events.

Because usage and security events across a network, node, or by a user are constantly changing, the trend curve that best fits the historical security events may not be the best predictor of future security events. Thus, the predictive analytics device may adapt its predictions for future security events based on real-time security events. A real-time security event is a security event that has just occurred, such as within a threshold time (e.g., within 1 minute). To determine whether a change of trend curves, and thus, a change in predicted security events, is desirable, the predictive analytics device may compare real-time security events to the predicted security events from the forecast trend curve. If the predicted security events deviate by more than a threshold value from the real-time security events, then the predictive analytics device may calculate additional model curves based on the real-time security events. The predictive analytics device may then determine which of the model curves best fits the real-time security events which then may be utilized by the SIEM system to predict future security events.

The predictive analytics device then may repeat this process, such that the forecast trend curve that best fits the real-time data is always utilized by the SIEM system to predict future security events. In this way, the SIEM system always has the latest forecast trend curve based on the most recent network, node, or user security event information.

The forecast trend curve may also comprise multiple sub-curves. For example, for specific periods of time, one model curve may fit the historical and/or real-time security event data better than a second model curve. However, for other periods of time, the second model curve may best fit the security event data. Thus, the forecast trend curve may comprise both model curves for the time period in which each model curve best fits the security event data. In this way, the two model curves act as a sub curve making up a portion of the entire forecast trend curve.

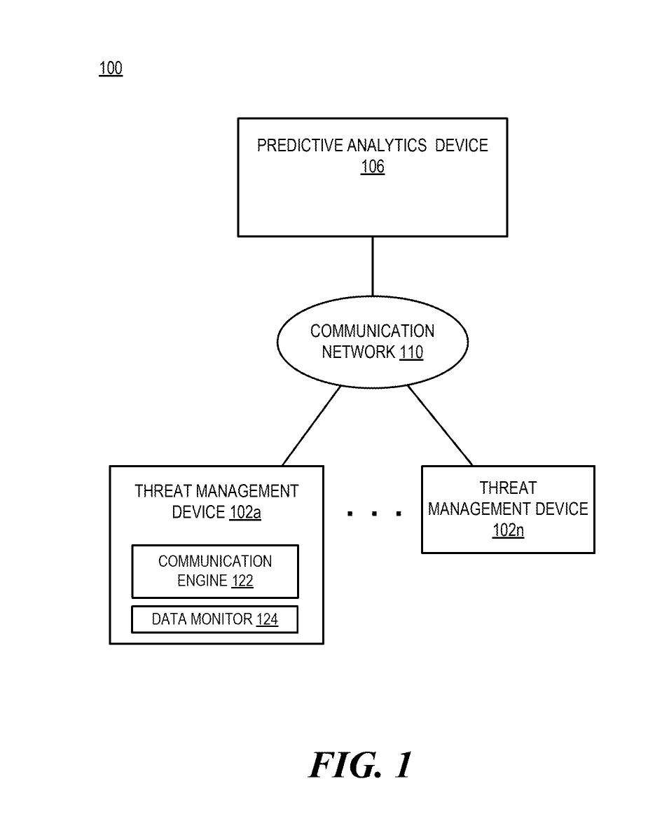

FIG. 1 is a block diagram of an adaptive predictive analytics system 100, according to one example. The system 100 can include threat management devices 102a-102n that communicate with a predictive analytics device 106, and other devices (not shown) via a communication network 110. In certain examples, the threat management devices 102 and/or predictive analytics device 106 are computing devices, such as servers, client computers, desktop computers, mobile computers, workstations, etc. In other examples, the devices can include special purpose machines. The devices can be implemented via a processing element, memory, and/or other components. In some examples, predictive analytics device 106 is a threat management device 102.

The threat management devices 102 can include a communication engine 122 to communicate with other devices on the communication network 110 or other networks. The threat management device 102 may also include a data monitor 124. The data monitor 124 can be used to receive information about one or more devices or entities such as security events. The security events may include security events for an entire network, such as communications network 110, for specific nodes in the network, such as threat management device 102, and/or for specific users.

In certain examples, a data monitor can correlate events into enhanced information. For example, data monitors can take information from security events and provide additional information, for example, hourly counts, event graphs (link analysis visualization), geographic event graphs, hierarchy maps, information about the last “N” events, the last state, a partial match of one or more rules, statistics, event and session reconciliation, system and system attribute monitors, asset category counts, etc.

The predictive analytics device 106 can receive the information collected by each data monitor 124. In some examples, the information can include the number of security events, the type of security events, the location of the security events, and other information about security events that are determined by data monitor 124. The predictive analytics device 106 may then determine a trend curve predicting future security events.

The communication network 110 can use wired communications, wireless communications, or combinations thereof. Further, the communication network 110 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 110 can be in the form of a direct network link between devices. Various communications structures and infrastructure can be utilized to implement the communication network(s).

By way of example, the devices 102 and 106 communicate with each other and other components with access to the communication network 110 via a communication protocol or multiple protocols. A protocol can be a set of rules that defines how nodes of the communication network 110 interact with other nodes. Further, communications between network nodes can be implemented by exchanging discrete packets of data or sending messages. Packets can include header information associated with a protocol (e.g., information on the location of the network node(s) to contact) as well as payload information.

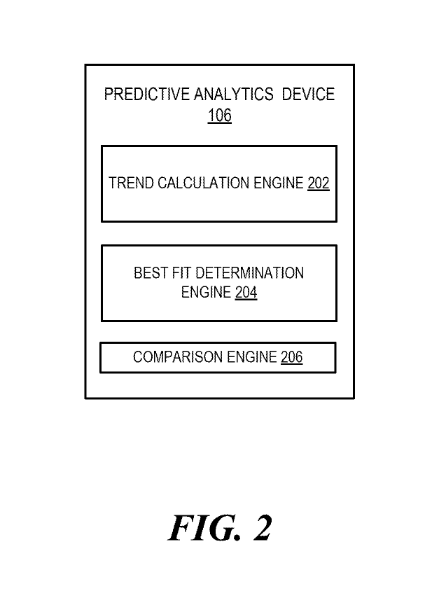

FIG. 2 shows a block diagram of an adaptive predictive analytics device 106, according to an example. The predictive analytics device 106 may comprise a trend calculation engine 202, best fit determination engine 204, and comparison engine 206. A memory (not shown) may store historical security event and real-time security event information that predictive analytics device 106 receives from data monitors 124 or other data collecting device. This memory may be any electronic, magnetic, optical, or other physical storage such as Random Access Memory (RAM), an Electrically Erasable Programmable Read-Only Memory (EEPROM), a storage drive, a Compact Disc Read Only Memory (CD-ROM), and the like. Historical security events and real-time security events may also be stored on a disc or in a database.

The trend calculation engine 202 calculates forecast trend curves utilizing different mathematical formulas for each forecast trend curve calculated (i.e., trend calculation engine 202 calculates model trend curves) based on the historical security event data. Trend calculation engine 202 may utilize any number of statistical trend methods to calculate the model trend curves. Examples of suitable model trend curves include simple moving average, geometric moving average, triangular moving average, parabolic moving average, double moving average, exponential moving average, double exponential moving average, triple exponential moving average, Holt's double exponential, Holt's triple exponential, adaptive response rate exponential smoothing, Holt Winter's additive, Holt Winter's multiplicative, Holt Winter's modified multiple seasonalities, additive decomposition, sparse series Croston's exponential, etc.

Best fit determination engine 204 determines which of the model curves calculated by calculation engine 202 best fits the actual historical security events. The model curve that does best fit the historical security event data is then utilized as the best fit forecast trend curve which may be used by system 100 to predict future security events.

Comparison engine 206 compares predicted security events from the best fit forecast trend curve with real-time security events. The comparison engine 206 then may determine whether the predicted security events from the best fit forecast trend curve deviate from the actual real-time security events by a threshold.

The comparison engine 206 may utilize a number of factors to determine upon what the threshold is based. For example, the threshold may be based on the number of predicted security events from the best fit forecast trend curve that deviate from the real time security events. In an alternative example, the threshold may be based on the amount a predicted security event from the best fit forecast trend curve deviates from a real-time security event. In yet another example, the threshold may be based on a variation percentage between a predicted security event from the best fit trend curve and a real-time security event. In an example, a user of system 100 may program the threshold into comparison engine 206 prior to comparison engine 206 making its comparison. Additionally, in an example, a user of system 100 may alter the threshold at any time.

If comparison engine 206 determines that the predicted security events from the best fit forecast trend curve do not deviate from the real-time security events by a threshold, the system 100 may continue to utilize the best fit forecast trend curve.

However, if comparison engine 206 determines that the predicted security events from the best fit forecast trend curve do deviate from the real-time security events by a threshold, calculation engine 202 calculates additional model trend curves utilizing the real-time security events. Determination engine 204 then determines which model trend curve, including the best fit forecast trend curve, best fits the real-time events. The model curve that best fits the real-time security events is then utilized as the new best fit trend curve by system 100 to provide predictions of future security events.

The predictive analytics device 106 then may repeat this process, such that the forecast trend curve that best fits the real-time data is always utilized by the system 100 to predict future security events. In this way, the system 100 always has the latest forecast trend curve based on the most recent network, node, or user security event information.

A processor, such as a central processing unit (CPU) or a microprocessor suitable for retrieval and execution of instructions and/or electronic circuits can be configured to perform the functionality of any of the engines used in the respective devices described herein. In certain scenarios, instructions and/or other information, such as configuration files, the web application code, etc., can be included in memory. Input/output interfaces may additionally be provided by the respective devices. For example, input devices, such as a keyboard, a touch interface, a mouse, a microphone, etc. can be utilized to receive input from an environment surrounding the computing device. Further, an output device, such as a display, can be utilized to present or output information to users. Examples of output devices include speakers, display devices, amplifiers, etc. Moreover, in certain embodiments, some components can be utilized to implement functionality of other components described herein. Input/output devices such as communication devices like network communication devices or wireless devices can also be considered devices capable of using the input/output interfaces.

Each of the engines of FIG. 2 may include, for example, hardware devices including electronic circuitry for implementing the functionality described herein. In addition or as an alternative, each engine may be implemented as a series of instructions encoded on a machine-readable storage medium of device and executed by at least one processor.

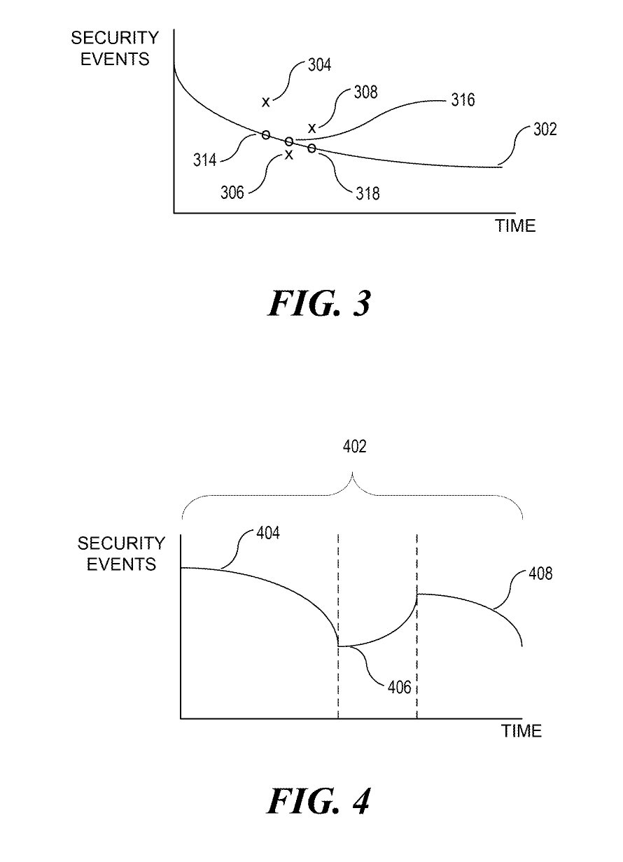

FIG. 3 shows an example forecast trend curve 302. In an example, forecast trend curve 302 is a best fit forecast trend curve. Forecast trend curve 302 has predicted security events 314, 316, and 318. As mentioned previously, comparison engine 206 compares predicted security events 314-318 with real-time security events, such as real-time security events 304, 306, and 308, to determine whether the predicted security events 314-318 deviate from the real-time security events 304-308 by a threshold.

For example, as mentioned previously, the threshold may be based ons the number of predicted security events from the best fit forecast trend curve that deviate from the real time security events. If the threshold number, for example, is two, because three real-time security events 304, 306, and 308 deviate from predicted security events 314-318, comparison engine 206 would determine that the predicted security events deviate from the real-time security events by more than the threshold, and calculation engine 202 would calculate additional model trend curves. If, however, the threshold level is four, because only three real time security events 304, 306, and 308 deviate from predicted security events 314-318, comparison engine 206 would determine that the predicted security events do not deviate from the real-time events by more than the threshold, and the best fit forecast trend curve would remain until two more real-time security events deviate from the predicted security events from forecast trend curve 302.

In an alternative example, as mentioned previously, the threshold may be based on the amount a predicted security event from the best fit forecast trend curve deviates from a real-time security event. In this example, comparison engine 206 would need to determine the difference between predicted security event 314 and real-time security event 304. If the difference is larger than a threshold value, then comparison engine 206 would determine that the predicted security events deviate from the real-time security events by more than the threshold, and calculation engine 202 would calculate additional model trend curves. If, however, the difference between predicted security event 314 and real-time security event 304 is not larger than the threshold value, then the best fit forecast trend curve 302 would remain and comparison engine 206 would then compare predicted security event 316 with real-time security event 306 and so on.

In yet another example, as mentioned previously, the threshold may be based on a variation percentage between a predicted security event from the best fit trend curve and a real-time security event. In this example, comparison engine 206 would need to determine the difference, on a percentage basis, between predicted security event 314 and real-time security event 304. If the percentage difference is larger than a threshold value, then comparison engine 206 would determine that the predicted security events deviate from the real-time security events by more than the threshold, and calculation engine 202 would calculate additional model trend curves. If, however, the percentage difference between predicted security event 314 and real-time security event 304 is not larger than the threshold value, then the best fit forecast trend curve 302 would remain and comparison engine 206 would then compare predicted security event 316 with real-time security event 306 and so on.

FIG. 4 shows an example forecast trend curve 402. In an example, forecast trend curve 402 is a best fit forecast trend curve. As previously mentioned, a best fit forecast trend curve may comprise multiple sub-curves. In FIG. 4, best fit forecast trend curve 402 comprises best fit forecast sub-curves 404, 406, and 408. Best fit forecast sub-curves 404-408 act in a similar manner to a single best fit forecast curve as described under FIG. 2; the predictive analytics device 106 may utilize real-time security events to best fit the most up-to-date forecast sub-curves as best fit forecast sub-curves 404-408 to make up best fit forecast trend curve 402.

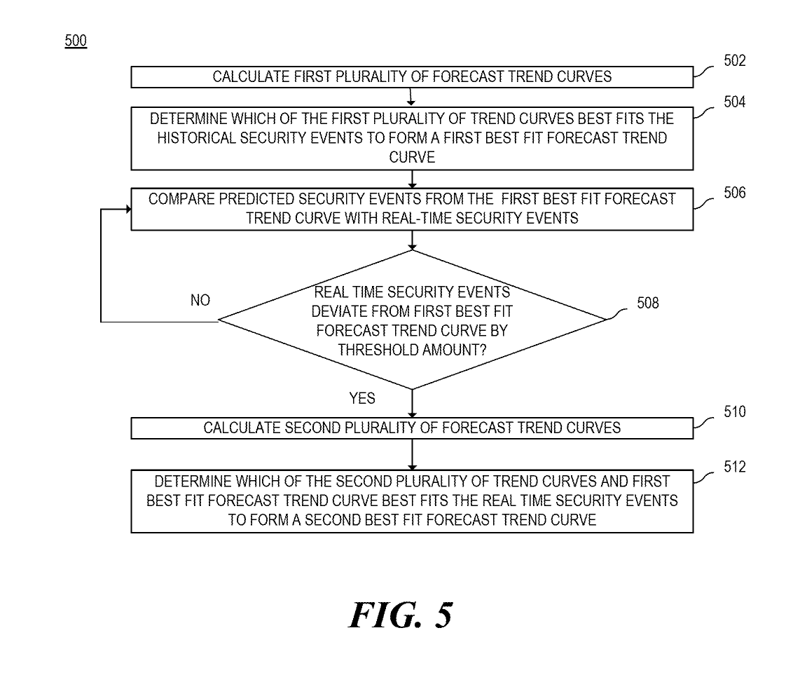

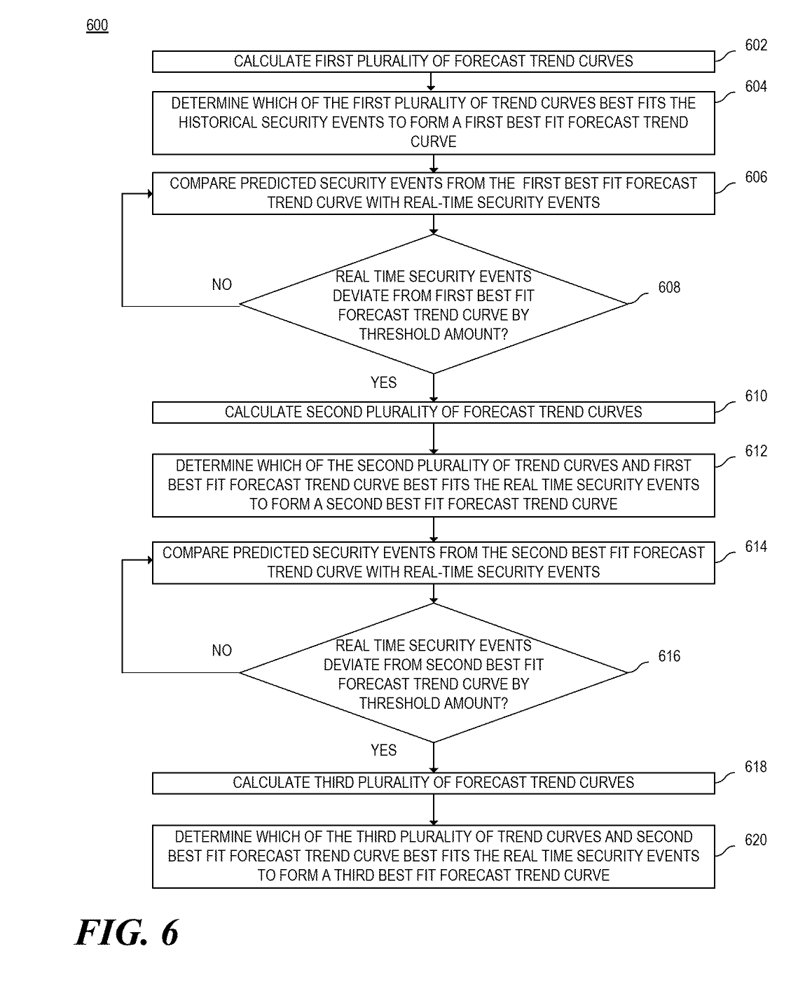

FIGS. 5 and 6 are flowcharts methods 500 and 600 for providing adaptive predictive analytics utilizing real-time security events. Although execution of methods 500 and 600 is described below with reference to system 100 and predictive analytics device 106, other suitable components for execution of methods 500 and 600 can be utilized (e.g., computing device 700). Additionally, the components for executing the methods 500 and 600 may be spread among multiple devices. Methods 500 and 600 may be implemented in the form of executable instructions stored on a machine-readable storage medium, such as storage medium 720, and/or in the form of electronic circuitry.

Method 500 begins at 502 with calculating a first plurality of forecast trend curves utilizing different mathematical formulas for each trend curve (i.e., model trend curves) and utilizing historical security events. At 504, a determination is made as to which of the plurality of forecast trend curves best fits the historical security events to form the first best fit forecast trend curve. The first best fit forecast trend curve may be comprised of multiple best fit forecast sub-curves.

The method continues at 506 with a comparison made of the predicted security events from the first best fit forecast trend curve with the real-time security events. At 508, a determination is made as to whether the real-time security events deviate from the first best fit forecast trend curve by a threshold amount. If not, then the method 500 continues at 506 with the comparison of the predicted security events from the first best fit forecast trend curve with the real-time security events. If the real-time events do deviate from the first best fit forecast trend curve by a threshold amount, then at 510, a calculation is made of a second plurality of model forecast trend curves.

At 512, the method continues with determining which of the second plurality of model forecast trend curves and first best fit forecast trend curve best fits the real-time security events to form a second best fit forecast trend curve. The second best fit forecast trend curve may be comprised of multiple best fit forecast sub-curves.

Method 600 begins at 602 with calculating a first plurality of forecast trend curves utilizing different mathematical formulas for each trend curve (i.e., model trend curves) and utilizing historical security events. At 604, a determination is made as to which of the plurality of forecast trend curves best fits the historical security events to form the first best fit forecast trend curve. The first best fit forecast trend curve may be comprised of multiple best fit forecast sub-curves.

The method continues at 606 with a comparison made of the predicted security events from the first best fit forecast trend curve with the real-time security events. At 608, a determination is made as to whether the real-time security events deviate from the first best fit forecast trend curve by a threshold amount. If not, then the method 600 continues at 606 with the comparison of the predicted security events from the first best fit forecast trend curve with the real-time security events. If the real-time events do deviate from the first best fit forecast trend curve by a threshold amount, then at 610, a calculation is made of a second plurality of model forecast trend curves.

At 612, the method continues with determining which of the second plurality of model forecast trend curves and first best fit forecast trend curve best fits the real-time security events to form a second best fit forecast trend curve. The second best fit forecast trend curve may be comprised of multiple best fit forecast sub-curves.

The method continues at 614 with a comparison made of the predicted security events from the second best fit forecast trend curve with real-time security events. At 616, a determination is made as to whether the real-time security events deviate from the second best fit forecast trend curve by a threshold amount. If not, then the method 600 continues at 614 with the comparison of the predicted security events from the second best fit forecast trend curve with the real-time security events. If the real-time security events do deviate from the second best fit forecast trend curve by a threshold amount, then at 618, a calculation is made of a third plurality of model forecast trend curves.

At 620, the method continues with determining which of the third plurality of model forecast trend curves and second best fit forecast trend curve best fits the real-time security events to form a third best fit forecast trend curve. The third best fit forecast trend curve may be comprised of multiple best fit forecast sub-curves.

The threshold may be based on the number of predicted security events from the first, second, and/or third best fit forecast trend curve that deviate from the real time security events. Additionally, the threshold may be based on the amount a predicted security event from the first, second, and/or third best fit forecast trend curve deviates from a real-time security event. Additionally, the threshold may be based on a variation percentage between a predicted security event from the first, second, and/or third best fit trend curve and a real-time security event.

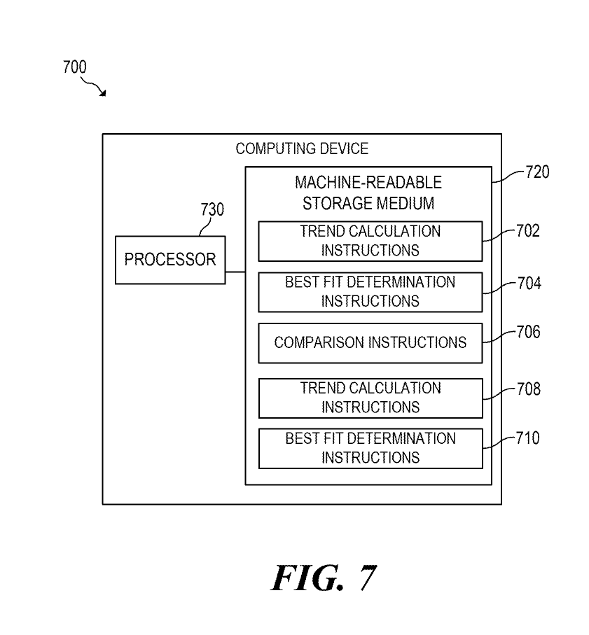

FIG. 7 is a block diagram of a computing device 700 capable of providing adaptive predictive analytics using real-time security events, according to an example. The computing device 700 includes, for example, a processor 730, and a machine-readable storage medium 720 including instructions 702,704, 706, 708, and 710 for providing adaptive predictive analytics using real-time security events. Computing device 700 may be, for example, a notebook computer, a slate computing device, a portable reading device, a wireless email device, a mobile phone, a workstation, a server, a desktop computer, or any other computing device.

Processor 730 may be, a central processing unit (CPU), a semiconductor-based microprocessor, a graphics processing unit (GPU), other hardware devices suitable for retrieval and execution of instructions stored in machine-readable storage medium 720, or combinations thereof. For example, the processor 730 may include multiple cores on a chip, include multiple cores across multiple chips, multiple cores across multiple devices (e.g., if the computing device 700 includes multiple node devices), or combinations thereof. Processor 730 may fetch, decode, and execute instructions 702-710 to implement methods 400 and 600. As an alternative or in addition to retrieving and executing instructions, processor 730 may include at least one integrated circuit (IC), other control logic, other electronic circuits, or combinations thereof that include a number of electronic components for performing the functionality of instructions 702-710.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 720 may be encoded with a series of executable instructions for providing adaptive predictive analytics using real-time security events.

Trend calculation instructions 702 can be used to calculate a first plurality of forecast trend curves utilizing different mathematical formulas for each trend curve (i.e., model trend curves) and utilizing historical security events. Best fit determination instructions 704 may be used to make a determination as to which of the plurality of forecast trend curves best fits the historical security events to form the first best fit forecast trend curve. The first best fit forecast trend curve may be comprised of multiple best fit forecast sub-curves.

Comparison instructions 706 cause the processor 730 to make a comparison of the predicted security events from the first best fit forecast trend curve with the real-time security events and make a determination as to whether the real-time security events deviate from the first best fit forecast trend curve by a threshold amount. If the real-time events do deviate from the first best fit forecast trend curve by a threshold amount, trend calculation instructions 708 cause the processor 730 to calculate a second plurality of model forecast trend curves.

The best fit determination instructions 710 can be used to determine which of the second plurality of model forecast trend curves and first best fit forecast trend curve best fits the real-time security events to form a second best fit forecast trend curve. The second best fit forecast trend curve may be comprised of multiple best fit forecast sub-curves.

The comparison instructions 706 may be used to make a comparison of the predicted security events from the second best fit forecast trend curve with the real-time security events and make a determination as to whether the real-time security events deviate from the second best fit forecast trend curve by a threshold amount. If the real-time security events do deviate from the second best fit forecast trend curve by a threshold amount, then trend calculation instructions 708 may cause the processor 730 to make a calculation of a third plurality of model forecast trend curves.

A determination of which of the third plurality of model forecast trend curves and second best fit forecast trend curve best fits the real-time security events to form a third best fit forecast trend curve may be caused by the best fit determination instructions 710. The third best fit forecast trend curve may be comprised of multiple best fit forecast sub-curves. This process may continue throughout computing device 700′s operation.

The threshold may be based on the number of predicted security events from the first, second, and/or third best fit forecast trend curve that deviate from the real time security events. Additionally, the threshold may be based on the amount a predicted security event from the first, second, and/or third best fit forecast trend curve deviates from a real-time security event. Additionally, the threshold may be based on a variation percentage between a predicted security event from the first, second, and/or third best fit trend curve and a real-time security event.

The forecast trend curve may also comprise multiple sub-curves. For example, for specific periods of time, one model curve may best fit the historical and/or real-time security event data than a second model curve. However, for other periods of time, the second model curve may best fit the security event data. Thus, the forecast trend curve may comprise both model curves for the time period in which each model curve best fits the security event data. In this way, the two model curves act as a sub curve for the forecast trend curve.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A predictive analytics device, comprising:
a trend calculation engine to calculate a first plurality of model forecast trend curves utilizing historical events;
a best fit determination engine to determine which of the first plurality of model forecast trend curves best fits the historical events to form a first best fit forecast trend curve; and
a comparison engine to compare predicted events from the first best fit forecast trend curve with the real-time events and determine that the predicted events from the first best fit forecast trend curve deviate by more than a threshold from the real-time events;
wherein the calculation engine further is to calculate, based on the real-time events deviating from the predicted events from the first best fit forecast trend curve by a threshold, a second plurality of model forecast trend curves utilizing the real-time events; and
wherein the best fit determination engine is further to determine which of the second plurality of forecast trend curves and first best fit forecast trend curve best fits the real-time events to form a second best fit forecast trend curve.

2. The device of claim 1, wherein the first best fit forecast trend curve comprises a plurality of best fit forecast trend sub-curves.

3. The device of claim 1, wherein the comparison engine is further to determine the threshold based on a number of predicted events from the first best fit forecast trend curve that deviate from the real-time events.

4. The device of claim 1, wherein the comparison engine is further to determine the threshold based on an amount the predicted events from the first best fit forecast trend curve deviates from the real-time events.

5. The device of claim 1, wherein the calculation engine is further to calculate, based on the real-time events deviating from predicted events from the second best fit forecast trend curve by a threshold amount, a third plurality of model forecast trend curves utilizing the real-time events; and
wherein the best fit determination engine is further to determine which of the third plurality of model forecast trend curves and second best fit forecast trend curve best fits the real-time events to form a third best fit forecast trend curve.

6. A non-transitory machine-readable storage medium storing instructions that, if executed by at least one processor of a device for providing predictive analytics for real-time security events, cause the device to:
calculate a first plurality of forecast trend curves utilizing different mathematical formulas for each of the first plurality of forecast trend curves and utilizing historical security events;
determine which of the first plurality of forecast trend curves best fits the historical security events to form a first best fit forecast trend curve;
compare predicted security events from the first best fit forecast trend curve with real-time security events;
calculate, based on the real-time security events deviating from the predicted security events from the first best fit forecast trend curve by a threshold amount, a second plurality of forecast trend curves utilizing a different mathematical formula from the formula utilized to form the first best fit forecast trend curve and utilizing the real-time security events; and
determine which of the second plurality of forecast trend curves and first best fit forecast trend curve best fits the real-time security events to form a second best fit forecast trend curve.

7. The non-transitory machine-readable storage medium of claim 6, further comprising instructions that, if executed by the at least one processor, causes the device to:
calculate, based on the real-time security events deviating from predicted security events from the second best fit forecast trend curve by a threshold amount, a third plurality of forecast trend curves utilizing a different mathematical formula from the formula utilized to form the second best fit forecast trend curve and utilizing the real-time security events; and
determine which of the third plurality of forecast trend curves and second best fit forecast trend curve best fits the real-time security events to form a third best fit forecast trend curve.

8. The non-transitory machine-readable storage medium of claim 6, wherein the first best fit forecast trend curve comprises a plurality of best fit forecast trend sub-curves.

9. The non-transitory machine-readable storage medium of claim 8, further comprising instructions that, if executed by the at least one processor, causes the device to determine the threshold based on a variation percentage between the predicted security events from the first best fit forecast trend curve and the real-time events.

10. The non-transitory machine-readable storage medium of claim 8, wherein the real-time security events comprise network activity security events, user activity security events, or node activity security events.

11. A method for providing predictive analytics utilizing real-time security events comprising:
calculating, by at least one processor, a first plurality of forecast trend curves utilizing historical security events;
determining, by the at least one processor, which of the first plurality of forecast trend curves best fits the historical security events to form a first best fit forecast trend curve;
comparing, by the at least one processor, predicted security events from the first best fit forecast trend curve with real-time security events;
calculating, by the at least one processor, based on the real-time security events deviating from the predicted security events from the first best fit forecast trend curve by a threshold amount, a second plurality of forecast trend curves utilizing the real-time security events; and
determining, by the at least one processor, which of the second plurality of forecast trend curves and first best fit forecast trend curve best fits the real-time security events to form a second best fit forecast trend curve.

12. The method of claim 11, further comprising:
calculating, by the at least one processor, based on the real-time security events deviating from predicted security events from the second best fit forecast trend curve by a threshold amount, a third plurality of forecast trend curves utilizing the real-time security events; and
determining, by the at least one processor, which of the third plurality of forecast trend curves and second best fit forecast trend curve best fits the real-time security events to form a third best fit forecast trend curve.

13. The method of claim 11, wherein the first best fit forecast trend curve comprises a plurality of best fit forecast trend sub-curves.

14. The method of claim 11, further comprising determining, by the at least one processor, the threshold based on a number of predicted security events from the first best fit forecast trend curve deviating from the real-time security events.

15. The method of claim 11, wherein the real-time security events comprise network activity security events, user activity security events, or node activity security events.
